(19) United States
(12) Patent Application Publication
(10) Pub. No.: US 2022/0085641 A1
(43) Pub. Date: Mar. 17, 2022

(54) POWER SYSTEM AND VEHICLE PROVIDED WITH THE SAME

(71) Applicant: SUMITOMO ELECTRIC INDUSTRIES, LTD., Osaka-shi, Osaka (JP)

(72) Inventor: Masayoshi HIROTA, Osaka-shi (JP)

(73) Assignee: SUMITOMO ELECTRIC INDUSTRIES, LTD., Osaka-shi, Osaka (JP)

(21) Appl. No.: 17/419,642

(22) PCT Filed: Oct. 8, 2019
(86) PCT No.: PCT/JP2019/039643

§ 371 Date: Jun. 29, 2021

(30) Foreign Application Priority Data
Feb. 1, 2019 (JP) 2019-016951

(51) Int. Cl. H02J 7/02; H02J 7/00; B60L 53/20; H02M 3/335; H02M 1/42; H02J 7/34; B60L 50/60; B60L 58/18; H01M 10/44; H01M 10/42

(52) U.S. Cl. CPC H02J 7/02; H01M 2220/20; B60L 53/20; H02M 3/33573; H02M 3/33584; H02M 1/4208; H02J 7/342; B60L 50/60; B60L 58/18; H01M 10/441; H01M 10/4257; H02J 2207/20; B60L 2210/10; H01M 2010/4271; H02J 7/0013

(57) ABSTRACT

A power system includes a first power supply circuit that supplies power to a first storage battery and a second power supply circuit that is electrically connected to the first power supply circuit and that supplies power to a second storage battery, wherein the first power supply circuit includes a first power conversion circuit, and the second power supply circuit uses the first power conversion circuit as a portion of the second power supply circuit and generates power to be supplied to the second storage battery.

### TECHNICAL FIELD

The present disclosure relates to a power system and a vehicle including the same. This application is based upon and claims the benefit of priority from Japanese Patent Application No. 2019-016951, filed on Feb. 1, 2019, the entire contents of which are incorporated herein by reference.

### BACKGROUND ART

Plug-in hybrid vehicles or electric vehicles are equipped with a step-down DC/DC converter for supplying power from a high voltage battery (for example, an output voltage 300V) for driving a motor to a low voltage battery (for example, a lead storage battery at the output voltage 12V) or a low voltage load. Hereinafter, the plug-in hybrid vehicle is referred to as a PHEV. An electric vehicle is referred to as an EV. Each of the PHEV and the EV is also equipped with a charger for enabling external power supply.

PTL 1 below proposes a power system of an electric vehicle in which a vehicle traveling system and an external power supply system are separated from each other in order to improve vehicle power supply efficiency of a PHEV and an EV. The power system of PTL 1 will be described with reference to FIG. 13. A power system 900 includes a charger 902, a sub DC/DC converter 904, a high voltage battery 906, a low voltage battery 908, a main DC/DC converter 910, and a power control unit (PCU) 918. Power system 900 further includes a PLG-ECU 912 for controlling an external charging operation, an HV-ECU 914 for controlling an operation of the electric vehicle during vehicle traveling, an MG-ECU 916 for controlling an operation of PCU 918, and relays 960 to 974. Power system 900 switches relays 960 to 974 according to the state of the vehicle. When the battery of the vehicle is charged by the AC power supply outside the vehicle (hereinafter referred to as external charging), power system 900 disconnects the vehicle running system and charges high voltage battery 906 and low voltage battery 908 by the AC power supplied from AC power supply 990. During running, power system 900 disconnects the external charging system and supplies power from high voltage battery 906 and low voltage battery 908 to a drive unit 992 and an auxiliary load 994. In the power system of PTL 1, as described above, the vehicle traveling system and the external charging system are separated from each other, thereby improving the durability of each component and the power supply efficiency of the entire vehicle.

### CITATION LIST

### Patent Literature

PTL 1: WO 2011/016135

### SUMMARY OF INVENTION

A power system according to an aspect of the present disclosure includes a first power supply circuit that supplies power to a first storage battery and a second power supply circuit that is electrically connected to the first power supply circuit and that supplies power to a second storage battery, wherein the first power supply circuit includes a first power conversion circuit, and the second power supply circuit uses the first power conversion circuit as a portion of the second power supply circuit and generates power to be supplied to the second storage battery.

A power system according to another aspect of the present disclosure includes a first storage battery, a second storage battery, a third storage battery, a first power supply circuit that supplies output power of the first storage battery to the second storage battery and a second power supply circuit that supplies output power of the first storage battery to the third storage battery, wherein the first power supply circuit includes a power conversion circuit, and the second power supply circuit uses the power conversion circuit as a portion of the second power supply circuit and generates power to be supplied to the third storage battery.

A vehicle according to still another aspect of the present disclosure includes the power system described above and a device to which power is supplied from the power system.

### BRIEF DESCRIPTION OF DRAWINGS

FIG. 1 is a block diagram showing a configuration of a power system according to a first embodiment of the present disclosure.

FIG. 2 is a schematic diagram according to a first embodiment of the present disclosure.

FIG. 3 is a block diagram showing the state of the power system in FIG. 1 during external charging.

FIG. 4 is a block diagram showing the state of the power system in FIG. 1 when the vehicle is running.

FIG. 5 is a block diagram showing a configuration of a power system according to a first modification.

FIG. 6 is a circuit diagram showing a specific configuration of a charger and a sub DC/DC converter in the power system in FIG. 5.

FIG. 7 is a block diagram showing a configuration of a power system according to a second modification.

FIG. 8 is a block diagram showing the configuration of a power system according to the second embodiment.

FIG. 9 is a block diagram showing the state of the power system in FIG. 8 when the vehicle is running.

FIG. 10 is a block diagram showing power supply between low voltage batteries in the power system in FIG. 8.

FIG. 11 is a block diagram showing power supply between low voltage batteries via a path different from that in FIG. 10.

FIG. 12 is a block diagram showing a configuration of a power system according to a third modification.

FIG. 13 is a block diagram showing a configuration of a power system of a conventional electric vehicle.

### DESCRIPTION OF EMBODIMENTS

### Problems to be Solved by Present Disclosure

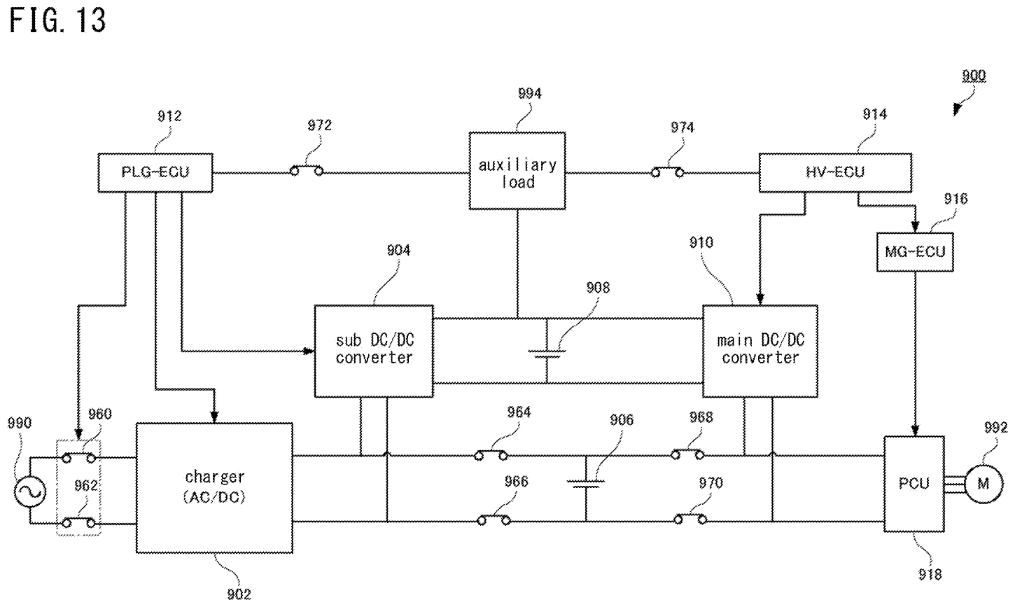

In the power system of PTL 1 (see FIG. 13), sub DC/DC converter 904 is also required in addition to charger 902 and main DC/DC converter 910 in order to separate the vehicle running system from the external power supply system. Therefore, in the configuration disclosed in PTL 1, there is a concern that the power system as a whole becomes relatively large.

Therefore, an object of the present disclosure is to provide a power system that can be further miniaturized and that can reduce space ratio occupied by the power supply unit in the vehicle when the power supply unit is mounted on the vehicle. The present disclosure also aims to provide a vehicle comprising such a power system.

### Advantageous Effects of Present Disclosure

According to the present disclosure, it is possible to further reduce the size of the power supply unit, and it is possible to reduce space ratio occupied by the power supply unit in the vehicle when the power supply unit is mounted on the vehicle.

### Description of Embodiments of the Present Disclosure

First, contents of embodiments of the present disclosure will be listed and described. At least some of the embodiments described below may be arbitrarily combined.

(1) A power system according to a first aspect of the present disclosure includes a first power supply circuit that supplies power to a first storage battery and a second power supply circuit that is electrically connected to the first power supply circuit and that supplies power to a second storage battery, wherein the first power supply circuit includes a first power conversion circuit, and the second power supply circuit uses the first power conversion circuit as a portion of the second power supply circuit and generates power to be supplied to the second storage battery. Thus, the first power conversion circuit can be shared for charging the first storage battery and charging the second storage battery, and the power supply unit can be miniaturized.

(2) Preferably, the first power conversion circuit includes a power factor improvement circuit, and an inverter circuit connected to the power factor improvement circuit. Thus, the first storage battery and the second storage battery can be efficiently charged.

(3) More preferably, the first power supply circuit further includes a transformer having a primary side connected to the first power conversion circuit, and a converter connected to a first secondary side of the transformer, and the converter converts power output from the first secondary side of the transformer and supplies the converted power to the first storage battery. Accordingly, a charging voltage suitable for the first storage battery can be supplied to the first storage battery.

(4) More preferably, the second power supply circuit includes a rectifier circuit connected to a second secondary side of the transformer, and the rectifier circuit rectifies power output from the second secondary side of the transformer and supplies the rectified power to the second storage battery. Thus, a charging voltage suitable for the second storage battery can be supplied to the second storage battery.

(5) Preferably, the converter is bidirectional, and the converter converts, in response to power being input from the first secondary side of the transformer, the power and outputs the converted power to the first storage battery, and converts, in response to power being input from the first storage battery, the power and outputs the converted power to the first secondary side of the transformer. Thus, power can be supplied from the first storage battery to the auxiliary load.

(6) More preferably, a third power supply circuit that converts power from the first storage battery is further included, wherein in response to the converter outputting power to the first secondary side of the transformer, the second power supply circuit and the third power supply circuit supply power to the second storage battery. Accordingly, it is possible to cope with a case where the consumption power of the auxiliary load connected to both ends of the second storage battery increases and the load of the third power supply circuit increases.

(7) More preferably, the power supply system further includes a third storage battery, a fourth power supply circuit that supplies output power of the first storage battery to the third storage battery; and a fifth power supply circuit that supplies output power of the first storage battery to the second storage battery, wherein the fourth power supply circuit includes a second power conversion circuit, and the fifth power supply circuit uses the second power conversion circuit as a portion of the fifth power supply circuit and generates power to be supplied to the second storage battery. Thus, the second power conversion circuit can be used in common for power supply from the first storage battery to the second storage battery and the third storage battery, and a power supply unit including three kinds of DC power supply voltages can be miniaturized.

(8) Preferably, the fourth power supply circuit and the fifth power supply circuit, in response to power being input to the fifth power supply circuit from the second storage battery, the power and supply the converted power from the fourth power supply circuit to the third storage battery, and convert, in response to power being input to the fourth power supply circuit from the third storage battery, the power and supply the converted power from the fifth power supply circuit to the second storage battery. Thus, the power supply efficiency can be improved.

(9) More preferably, the power system further includes a sixth power supply circuit, wherein the sixth power supply circuit converts, in response to power being input from the second storage battery, the power and supplies the converted power to the third storage battery, and converts, in response to power being input from the third storage battery, the power and supplies the converted power to the second storage battery. Thus, the power supply efficiency can be improved. In addition, redundancy can be provided in the power supply path, and a more reliable power system can be realized.

(10) A power system according to a second aspect of the present disclosure includes a first storage battery, a second storage battery, a third storage battery, a first power supply circuit that supplies output power of the first storage battery to the second storage battery, and a second power supply circuit that supplies output power of the first storage battery to the third storage battery, wherein the first power supply circuit includes a power conversion circuit, and the second power supply circuit uses the power conversion circuit as a portion of the second power supply circuit and generates power to be supplied to the third storage battery. Thus, the power conversion circuit can be shared for power supply from the first storage battery to the second storage battery and the third storage battery, and a power supply unit including three kinds of DC power supply voltages can be miniaturized.

(11) Preferably, the first power supply circuit and the second power supply circuit convert, in response to power being input to the first power supply circuit from the second storage battery, the power and supply the converted power from the second power supply circuit to the third storage battery, and convert, in response to power being input to the second power supply circuit from the third storage battery, the power and supply the converted power from the first power supply circuit to the second storage battery. Thus, the power supply efficiency can be improved.

(12) More preferably, the power system further includes a third power supply circuit, wherein the third power supply circuit converts, in response to power being input from the second storage battery, the power and supplies the converted power to the third storage battery, and converts, in response to power being input from the third storage battery, the power and supplies the converted power to the second storage battery. Thus, the power supply efficiency can be improved. In addition, redundancy can be provided in the power supply path, and a more reliable power system can be realized.

(13) A vehicle according to a third aspect of the present disclosure includes the power system described above and a device that is supplied with power from the power system. Thus, the space ratio of the power supply unit in the vehicle can be reduced.

### DETAILS OF EMBODIMENTS OF PRESENT DISCLOSURE

In the following embodiments, the same components are denoted by the same reference numerals. Their names and functions are also the same. Therefore, detailed description thereof will not be repeated.

### First Embodiment

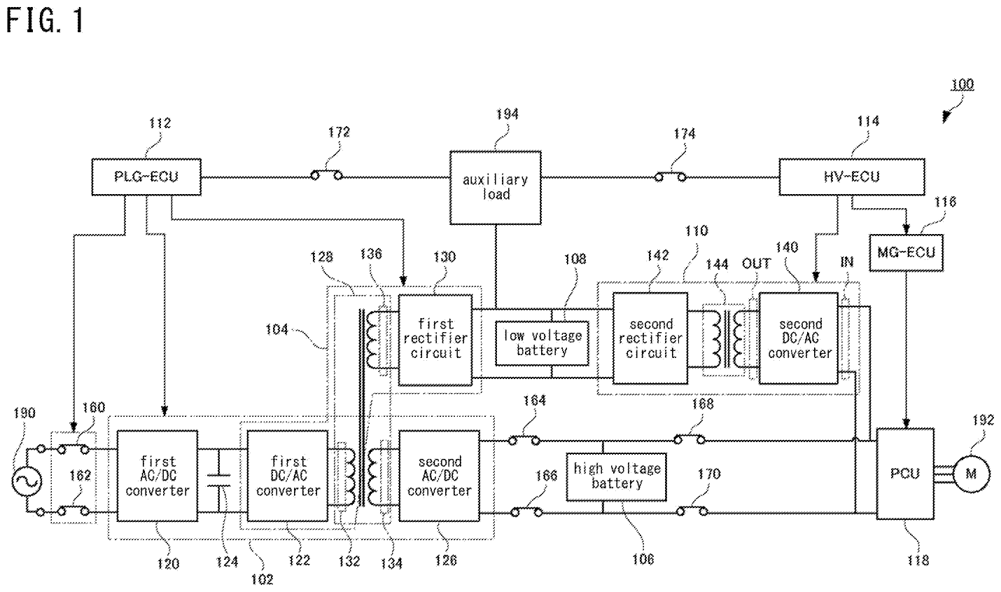

Referring to FIG. 1, a power system 100 according to a first embodiment of the present disclosure includes a charger 102, a sub DC/DC converter 104, a high voltage battery 106, and a low voltage battery 108. Power system 100 further includes a main DC/DC converter 110, a PLG-ECU 112, an HV-ECU 114, an MG-ECU 116, and a PCU 118. Charger 102, sub DC/DC converter 104, and main DC/DC converter 110 function as first to third power supply circuits, respectively. High voltage battery 106 and low voltage battery 108 function as first and second storage batteries, respectively.

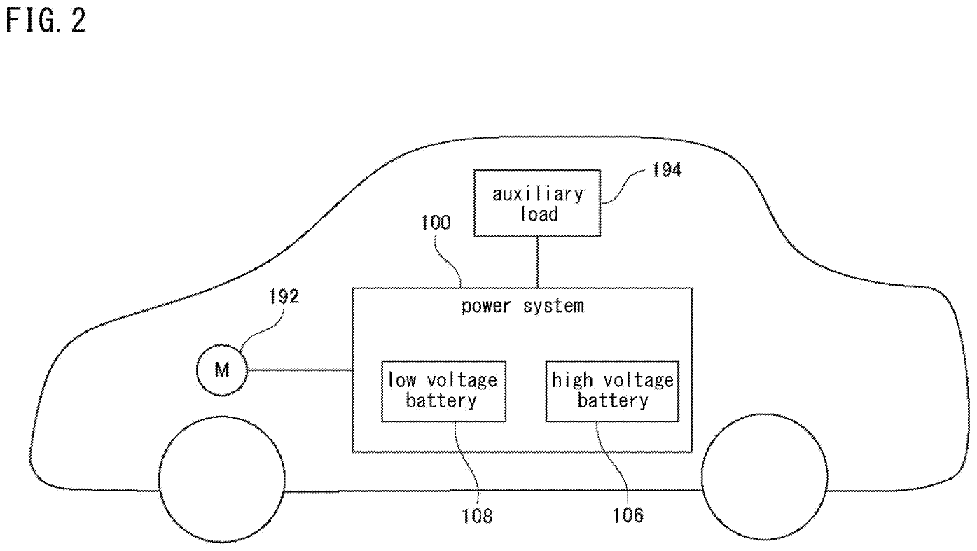

Referring to FIG. 2, power system 100 is mounted on a vehicle such as a PHEV or an EV. Power system 100 charges high voltage battery 106 and low voltage battery 108 with AC power supplied from an AC power supply 190, and supplies power to a drive unit 192 and an auxiliary load 194 when the vehicle is running. Drive unit 192 is an electric drive device such as a main engine motor. Auxiliary load 194 is an accessory device necessary for operating the engine and the motor. For example, the accessory device is mainly a cell motor, an alternator, a radiator cooling fan, and the like. However, auxiliary load 194 may include a headlight, a wiper drive unit, a navigation device, and the like. The time when the vehicle is running is not limited to the traveling state of the vehicle. The time when the vehicle is running includes a state in which the vehicle is stopped and power is supplied to a headlight or the like. In the case of the PHEV, the idling state of the engine is also included when the vehicle travels.

High voltage battery 106 outputs a high voltage (e.g., about 300V) to operate drive unit 192. Low voltage battery 108 supplies a low voltage (for example, about 12V) for operating auxiliary load 194, PLG-ECU 112, and HV-ECU 114.

PLG-ECU 112 controls components related to external charging (charging of high voltage battery 106 and low voltage battery 108 by an external AC power supply). Specifically, PLG-ECU 112 supplies power for operating elements (for example, semiconductor elements) constituting charger 102 and sub DC/DC converter 104. HV-ECU 114 controls components related to power supply to drive unit 192 and auxiliary load 194 during vehicle running. Specifically, HV-ECU 114 supplies power for operating elements (for example, semiconductor elements) constituting main DC/DC converter 110 and MG-ECU 116.

PCU 118 converts the output power of high voltage battery 106 into power for driving drive unit 192, and supplies the power to drive unit 192. PCU 118 includes, for example, an inverter, generates AC (three phase AC if high voltage battery 106 is driven by three phase current) from DC, and supplies the AC to drive unit 192. MG-ECU 116 controls PCU 118 under the control of HV-ECU 114.

If the vehicle on which power system 100 is mounted is an EV, the configuration shown in FIG. 1 allows the EV to travel. On the other hand, if the vehicle on which power system 100 is mounted is a PHEV, the vehicle includes an engine in addition to drive unit 192. Therefore, the PHEV can travel by operating the engine and drive unit 192 in cooperation with each other.

Charger 102 includes a first AC/DC converter 120, a first DC/AC converter 122, a capacitor 124, a second AC/DC converter 126, and a first transformer 128. Capacitor 124 is connected to the connection between the output end of first AC/DC converter 120 and the input end of first DC/AC converter 122. First transformer 128 connects an output end of first DC/AC converter 122 and an input end of second AC/DC converter 126. The input terminal of first AC/DC converter 120 is connected to AC power supply 190 via relays 160 and 162. First AC/DC converter 120 converts an input AC voltage into a DC voltage and outputs the DC voltage. First AC/DC converter 120 functions as a power factor improvement circuit. First DC/AC converter 122 converts an input DC voltage into an AC voltage and outputs the AC voltage. First DC/AC converter 122 functions as an inverter. First AC/DC converter 120 and first DC/AC converter 122 function as a power conversion circuit. Second AC/DC converter 126 converts an input AC voltage into a DC voltage and outputs the DC voltage. The AC voltage input to second AC/DC converter 126 is an AC voltage generated at a first secondary side end 134 of first transformer 128 when the AC output of first DC/AC converter 122 is supplied to a primary side end 132 of the first transformer 128. The output end of second AC/DC converter 126 is connected to both ends of high voltage battery 106 via relays 164 and 166.

Accordingly, when relays 160 to 166 are turned on during external charging, the DC voltage (the output voltage of second AC/DC converter 126) generated from the AC voltage from AC power supply 190 is supplied to high voltage battery 106, and high voltage battery 106 is charged. The output voltage of second AC/DC converter 126 is preferably a voltage value suitable for charging high voltage battery 106. In order to generate a voltage suitable for charging high voltage battery 106, a first transformer 128 having a transformation ratio (a voltage ratio between a primary side and a secondary side) suitable for generating the voltage may be used. That is, by using first transformer 128 having an appropriate voltage ratio between primary side end 132 and first secondary side end 134, a charging voltage suitable for high voltage battery 106 can be generated.

Sub DC/DC converter 104 includes a first DC/AC converter 122, a first rectifier circuit 130, and a first transformer 128 connecting an output end of first DC/AC converter 122 and an input end of first rectifier circuit 130. First rectifier circuit 130 rectifies and smoothes an input AC voltage and outputs a DC voltage. The AC voltage input to first rectifier circuit 130 is an AC voltage generated at a second secondary side end 136 of first transformer 128 when the AC output of first DC/AC converter 122 is supplied to primary side end 132 of the first transformer 128. An output end of first rectifier circuit 130 is connected to low voltage battery 108 and auxiliary load 194. Thus, first DC/AC converter 122 is a component of sub DC/DC converter 104 as well as a component of charger 102 as described above. That is, first DC/AC converter 122 is shared by charger 102 and sub DC/DC converter 104.

Accordingly, when relays 160 and 162 are turned on at the time of external charging, voltage generated from the AC voltage supplied from AC power supply 190 is supplied to low voltage battery 108 and auxiliary load 194, and low voltage battery 108 is charged. The output voltage of first rectifier circuit 130 is preferably a voltage value suitable for charging low voltage battery 108. In order to generate a voltage suitable for charging low voltage battery 108, a first transformer 128 having a transformation ratio (a voltage ratio between a primary side and a secondary side) suitable for generating the voltage may be used. That is, by using first transformer 128 having an appropriate voltage ratio between primary side end 132 and second secondary side end 136, a charging voltage suitable for low voltage battery 108 can be generated.

Main DC/DC converter 110 includes a second DC/AC converter 140, a second rectifier circuit 142, and a second transformer 144 connecting an output end of second DC/AC converter 140 and an input end of second rectifier circuit 142. Like first DC/AC converter 122, second DC/AC converter 140 converts a DC voltage on the input side IN into an AC voltage and outputs the AC voltage from the output side OUT. Like first rectifier circuit 130, second rectifier circuit 142 rectifies and smoothes an input AC voltage (output of second transformer 144) and outputs a DC voltage to low voltage battery 108 side. The AC voltage input to second rectifier circuit 142 is an AC voltage generated on the secondary side of second transformer 144 by supplying the AC output of second DC/AC converter 140 to the primary side of second transformer 144. An output terminal of second rectifier circuit 142 is connected to low voltage battery 108 and auxiliary load 194.

Thus, when relays 168 and 170 are turned on while the vehicle is running, the low-voltage DC voltage generated from the high-voltage DC voltage supplied from high voltage battery 106 is supplied to auxiliary load 194. The output voltage of second rectifier circuit 142 is preferably a voltage value suitable for auxiliary load 194. For this purpose, the transformation ratio (a voltage ratio between the primary side and the secondary side) of second transformer 144 may be set to an appropriate value.

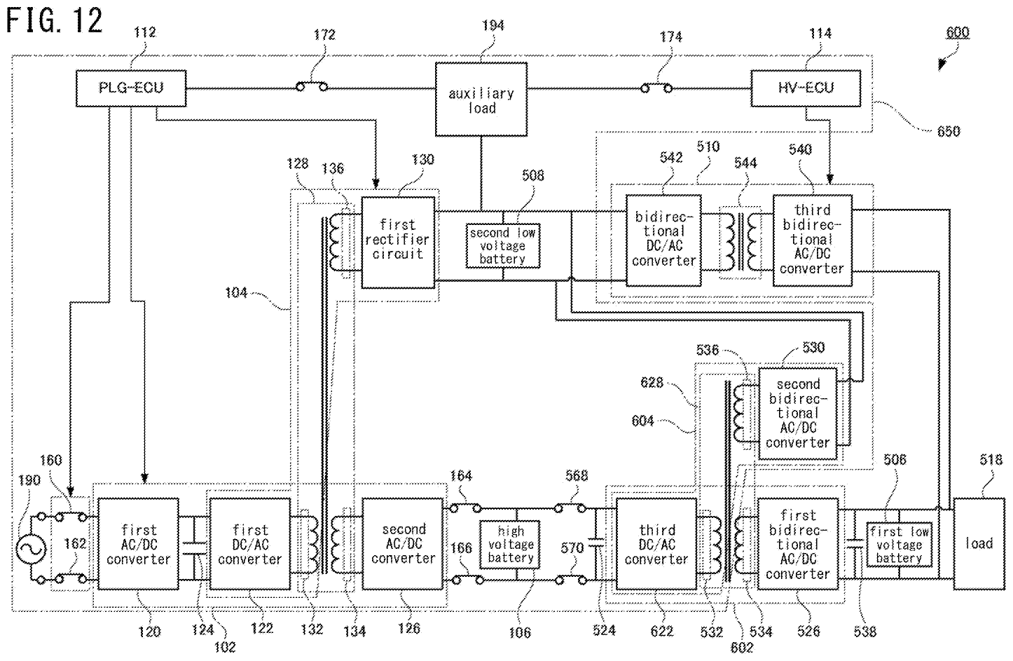

Thus, in power system 100, first DC/AC converter 122 is a component common to charger 102 and sub DC/DC converter 104. Therefore, power system 100 is smaller than the power system having the conventional configuration as shown in FIG. 12, and when power system 100 is mounted on a vehicle, the space ratio occupied by power system 100 in the vehicle can be further reduced. In addition, according to this configuration, it is possible to improve the durability of each component and the power supply efficiency of the entire vehicle while reducing the size of the power system.

Power system 100 includes first AC/DC converter 120 functioning as a power factor improvement circuit and first DC/AC converter 122 functioning as an inverter, thereby efficiently charging high voltage battery 106 and low voltage battery 108.

(Operation During External Charging)

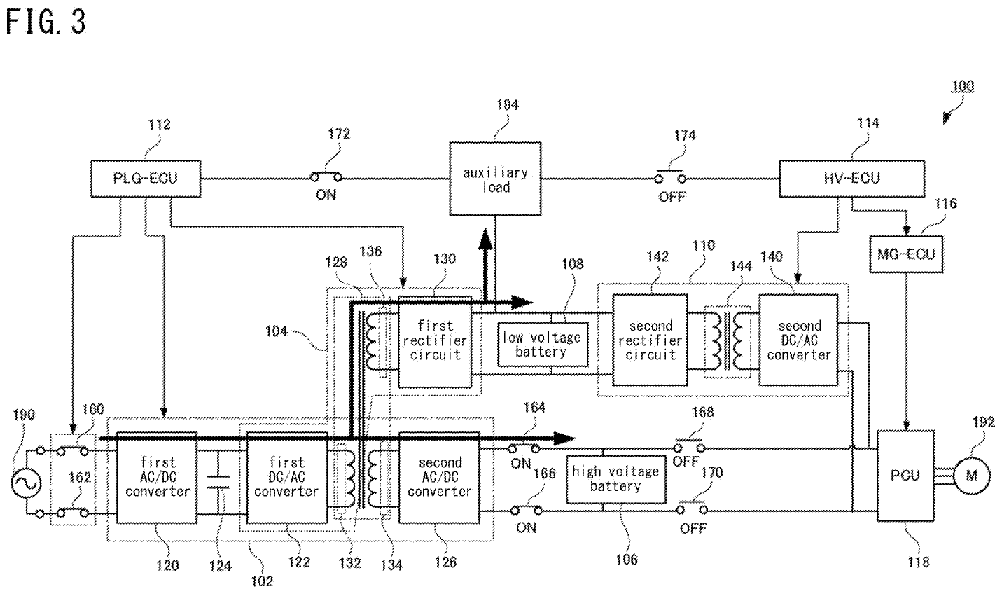

The operation of power system 100 during external charging will be described with reference to FIG. 3. In the initial state, power system 100 is not connected to AC power supply 190, and all of relays 160 to 174 of power system 100 are turned off.

During external charging, power system 100 is connected to an AC power supply 190 (for example, a commercial power supply) via, for example, a cable (not shown). When AC power supply 190 and power system 100 are connected to each other, relay 172 is turned on, and the power supply from low voltage battery 108 to PLG-ECU 112 via auxiliary load 194 is started. The detection of the connection between AC power supply 190 and power system 100 and the turning on of relay 172 are performed, for example, by an ECU (not shown) different from PLG-ECU 112 and HV-ECU 114.

Accordingly, PLG-ECU 112 is activated, and PLG-ECU 112 turns on relays 160 to 166. At this time, relay 168, relay 170, and relay 174 remain off. In addition, PLG-ECU 112 supplies power to charger 102 and sub DC/DC converter 104 to operate charger 102 and sub DC/DC converter 104. When charger 102 is operated, as described above, the AC voltage from AC power supply 190 is converted into the high DC voltage and supplied to high voltage battery 106, and high voltage battery 106 is charged. At the same time, as sub DC/DC converter 104 operates, as described above, the AC voltage from AC power supply 190 is converted into the low-voltage DC voltage and supplied to low voltage battery 108, and low voltage battery 108 is charged. The direction of the current at this time is shown by the thick arrow in FIG. 3.

At this time, if the voltage ratio between primary side end 132 and first secondary side end 134 is appropriately set in the first transformer 128, an appropriate charging voltage can be supplied to high voltage battery 106. Similarly, in the first transformer 128, if the voltage ratio between primary side end 132 and second secondary side end 136 is appropriately set, an appropriate charging voltage can be supplied to low voltage battery 108.

(Operation During Vehicle Running)

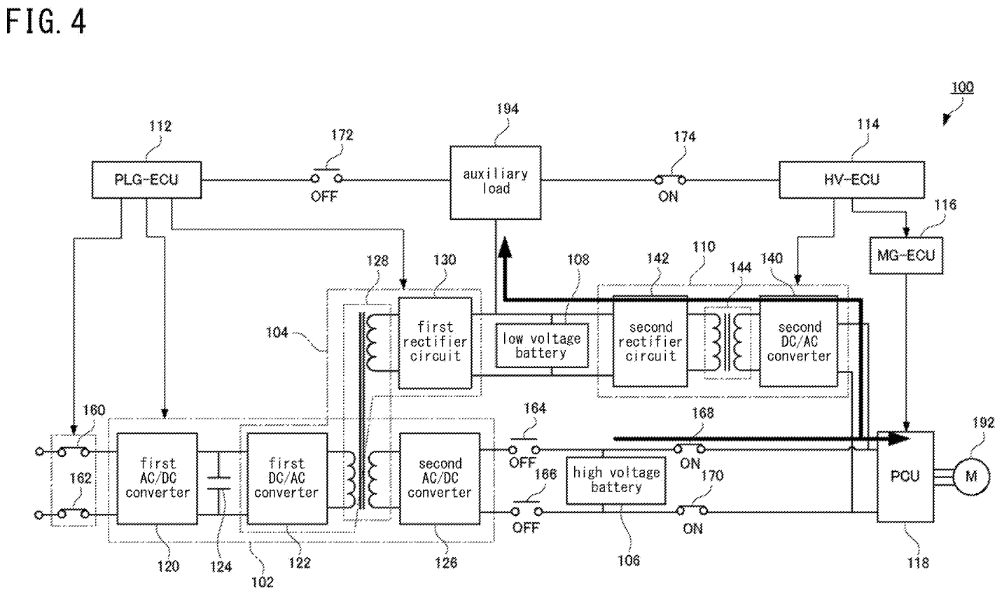

Referring to FIG. 4, the operation of power system 100 when the vehicle is running will be described. In the initial state, power system 100 is not connected to AC power supply 190, and all of relays 160 to 174 of power system 100 are turned off.

When an ignition key, a wireless key, or the like is operated, relay 174 is turned on, and power supply from low voltage battery 108 to HV-ECU 114 via auxiliary load 194 is started. The detection of the operation of the ignition key, the wireless key, or the like and the turning on of relay 174 are performed, for example, by an ECU (not shown) different from PLG-ECU 112 and HV-ECU 114.

Accordingly, HV-ECU 114 is activated, and HV-ECU 114 turns on relays 168 and 170. At this time, relays 160 to 166 and 172 remain off.

HV-ECU 114 supplies power to main DC/DC converter 110, MG-ECU 116, and PCU 118 to operate main DC/DC converter 110, MG-ECU 116, and PCU 118. When MG-ECU 116 and PCU 118 operate, as described above, the high-voltage DC voltage supplied from high voltage battery 106 is supplied to PCU 118, converted into AC power by PCU 118, and then the AC power is supplied to drive unit 192. Thus, drive unit 192 starts operating. MG-ECU 116 controls PCU 118 to control the operation of drive unit 192. When main DC/DC converter 110 operates, as described above, the high DC voltage supplied from high voltage battery 106 to main DC/DC converter 110 is converted into the low DC voltage, and the low DC voltage is supplied to auxiliary load 194. The direction of the current at this time is shown the thick arrow in FIG. 4.

At this time, if the voltage ratio between the primary side and the secondary side is appropriately set in second transformer 144, an appropriate voltage can be supplied to auxiliary load 194.

(First Modification)

When the vehicle is running, the power consumption of the auxiliary load may vary. For example, power consumption is increased by turning on a headlight during nighttime driving or turning on an air conditioner. This can cause the load of main DC/DC converter 110 to increase. The first modification is intended to deal with such a problem.

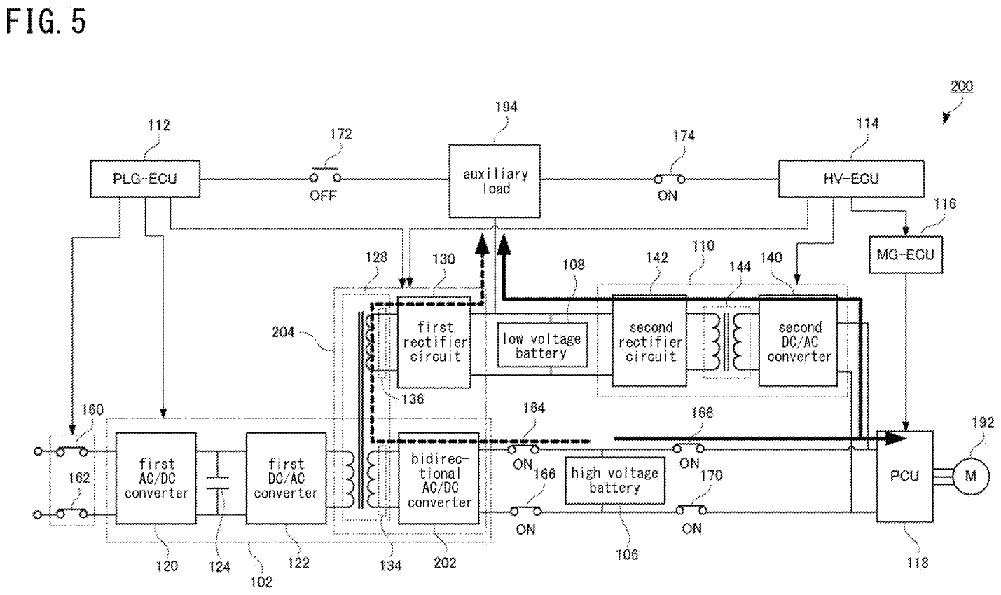

Referring to FIG. 5, a power system 200 according to this modification is configured in the same manner as power system 100 in FIG. 1. Power system 200 is mounted on a PHEV or an EV. Power system 200 differs from power system 100 in the following points. That is, second AC/DC converter 126 (see FIG. 1) of power system 100 is replaced by a bidirectional AC/DC converter 202. HV-ECU 114 also controls power supply to a sub DC/DC converter 204 in addition to control of power supply to main DC/DC converter 110 and MG-ECU 116.

Bidirectional AC/DC converter 202 has a function of bidirectionally converting AC power and DC power. That is, like second AC/DC converter 126, bidirectional AC/DC converter 202 receives an output voltage (AC voltage) from first secondary side end 134 of the first transformer 128, converts the AC voltage into a DC voltage, outputs the DC voltage, and supplies the DC voltage to high voltage battery 106. In addition, when a DC voltage is supplied from high voltage battery 106, bidirectional AC/DC converter 202 converts the DC voltage into an AC voltage and outputs the AC voltage to first secondary side end 134 of the first transformer 128. Thus, when the vehicle is running, bidirectional AC/DC converter 202, the first transformer 128, and first rectifier circuit 130 function as sub DC/DC converter 204.

Similarly to power system 100, in power system 200, during external charging, high voltage battery 106 and low voltage battery 108 are charged by connecting a commercial AC power supply to relays 160 and 162. When the vehicle is running, the voltage supplied from high voltage battery 106 is supplied to PCU 118 and main DC/DC converter 110, converted, and supplied to drive unit 192 and auxiliary load 194, respectively. This current direction is shown by the thick solid arrow in FIG. 5.

When the power consumption of auxiliary load 194 increases while the vehicle is running, the load of main DC/DC converter 110 increases. In this case, in power system 200, relays 164 and 166 are turned on by HV-ECU 114, and the DC voltage from high voltage battery 106 is supplied to bidirectional AC/DC converter 202. Further, HV-ECU 114 starts power supply to sub DC/DC converter 204, and operates bidirectional AC/DC converter 202 and first rectifier circuit 130. Accordingly, bidirectional AC/DC converter 202 converts the supplied DC voltage into an AC voltage and supplies the AC voltage to first secondary side end 134 of the first transformer 128. At this time, first secondary side end 134 and second secondary side end 136 of first transformer 128 function as the primary side and the secondary side of the transformer, respectively. Therefore, an AC voltage is supplied from second secondary side end 136 to first rectifier circuit 130. First rectifier circuit 130 converts the supplied AC voltage into a DC voltage and supplies the DC voltage to auxiliary load 194. This current direction is indicated by the thick dashed arrow in FIG. 5.

This allows power system 200 to suppress the increase in the load of main DC/DC converter 110. Therefore, main DC/DC converter 110 can be prevented from being damaged due to an overload of main DC/DC converter 110, and the life of main DC/DC converter 110 can be reduced.

### EXAMPLES

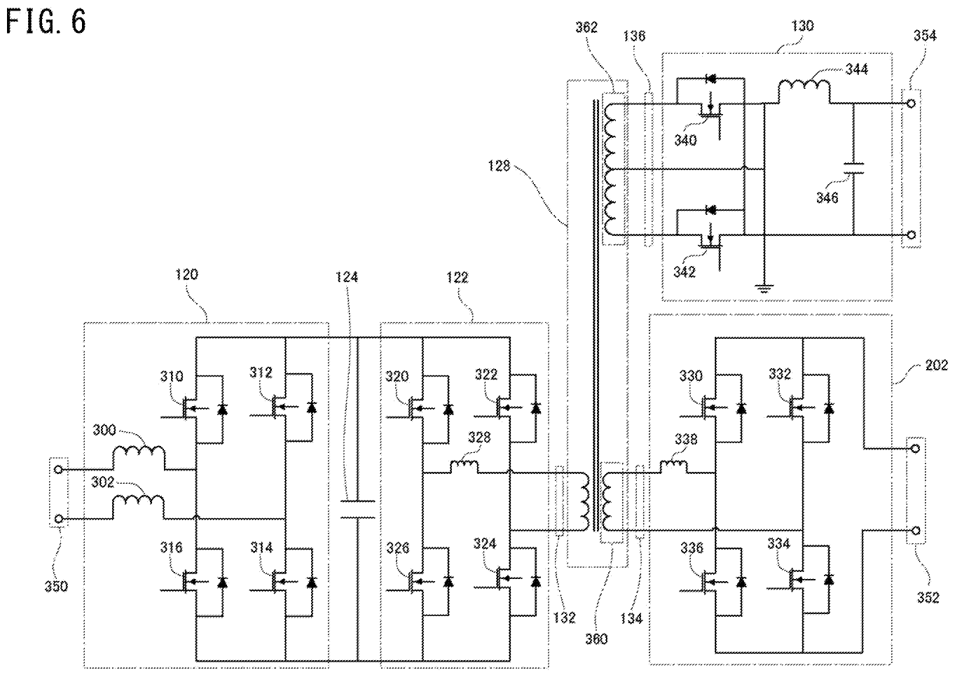

A specific circuit of first AC/DC converter 120, first DC/AC converter 122, first rectifier circuit 130 and bidirectional AC/DC converter 202 in FIG. 5 is shown in FIG. 6. Referring to FIG. 6, first AC/DC converter 120 includes inductors 300 and 302, and switch elements 310 to 316 forming a full-bridge circuit. In FIG. 6, each switch element is formed of, for example, an FET (Field Effect Transistor) having a freewheeling diode. For the purpose of protection from a surge current or the like, the switch element and the freewheeling diode are connected in parallel so that forward bias directions are opposite to each other. Two input ends of the full bridge circuit constituted by switch elements 310 to 316 are connected to inductors 300 and 302, respectively. Two output terminals of the full bridge circuit are connected to both ends of capacitor 124. Thus, during external charging, first AC/DC converter 120 can generate a DC voltage from an AC voltage input to terminal 350 from a commercial AC power supply or the like and supply the DC voltage to both ends of capacitor 124.

First DC/AC converter 122 includes switch elements 320 to 326 constituting a full-bridge circuit, and an inductor 328. One terminal of inductor 328 is connected to one of two output terminals of the full bridge circuit constituted by switch elements 320 to 326. The other terminal of inductor 328 is connected to one terminal of a primary side end (both ends of primary winding) 132 of the first transformer 128. The other of the two output terminals of the full bridge circuit constituted by switch elements 320 to 326 is connected to the other terminal of primary side end 132. First DC/AC converter 122 converts a DC voltage input from capacitor 124 into an AC voltage and outputs the AC voltage to primary side end 132 of the transformer 128.

Bidirectional AC/DC converter 202 includes switch elements 330 to 336 constituting a full-bridge circuit, and an inductor 338. One terminal of inductor 338 is connected to one of a pair of terminals (the pair of terminals not connected to terminal 352) of the full bridge circuit constituted by switch elements 330 to 336. The other terminal of inductor 338 is connected to one terminal of a first secondary side end (both ends of the first secondary winding) 134 of the first transformer 128. The other of the pair of terminals (the pair of terminals not connected to terminal 352) of the full bridge circuit constituted by switch elements 330 to 336 is connected to the other terminal of first secondary side end 134. With this configuration, bidirectional AC/DC converter 202 can bidirectionally convert AC power and DC power. That is, when an AC voltage is input from first secondary side end 134 of the first transformer 128, bidirectional AC/DC converter 202 converts the AC voltage into a DC voltage and outputs the DC voltage to terminal 352. When a DC voltage is input from terminal 352, bidirectional AC/DC converter 202 outputs the DC voltage as an AC voltage to first secondary side end 134 of the first transformer 128. Thus, during external charging, bidirectional AC/DC converter 202 converts the AC voltage output from first secondary side end 134 into a DC voltage by the AC voltage output from first DC/AC converter 122 to primary side end 132. The converted DC voltage is supplied from terminal 352 as a voltage for charging high voltage battery 106.

On the other hand, when the power consumption of auxiliary load 194 increases while the vehicle is running, bidirectional AC/DC converter 202 converts the DC voltage input from high voltage battery 106 to terminal 352 into an AC voltage and outputs the AC voltage to first secondary side end 134. When an AC voltage is supplied to first secondary side end 134, an AC voltage is generated at second secondary side end 136 by the interaction between first secondary winding 360 and second secondary winding 362 of the first transformer 128. The AC voltage generated at second secondary side end 136 is converted into a DC voltage by first rectifier circuit 130 and supplied to auxiliary load 194.

First rectifier circuit 130 includes switch elements 340 and 342, an inductor 344, and a capacitor 346. Second secondary winding 362 connected to the input side (second secondary side end 136) of first rectifier circuit 130 is a center tap coil. Thus, first rectifier circuit 130 rectifies and smoothes the AC voltage generated in second secondary winding 362, and outputs it as a DC voltage from terminal 354. Therefore, when the power consumption of auxiliary load 194 increases while the vehicle is running, first rectifier circuit 130 generates a DC voltage from the AC voltage output from second secondary side end 136 and supplies the DC voltage to auxiliary load 194 from terminal 354. As described above, the AC voltage output from second secondary side end 136 is a voltage generated by the interaction between first secondary winding 360 and second secondary winding 362 due to the AC voltage output from bidirectional AC/DC converter 202 to first secondary side end 134.

Thus, first AC/DC converter 120, capacitor 124, first DC/AC converter 122, the first transformer 128, and bidirectional AC/DC converter 202 shown in FIG. 6 constitute a DC/DC converter of a DAB (Dual Active Bridge) system. Therefore, these circuits function as a charger. Bidirectional AC/DC converter 202, the first transformer 128, and first rectifier circuit 130 shown in FIG. 6 constitute a DC/DC converter having a full-bridge/center-tap configuration and function as a sub DC/DC converter. Second DC/AC converter 140 and second transformer 144 in FIG. 5 may be configured with circuits similar to bidirectional AC/DC converter 202 and first rectifier circuit 130, respectively. In this case, second DC/AC converter 140, second transformer 144, and second rectifier circuit 142 constitute a DC/DC converter having a full-bridge/center-tap configuration and function as a main DC/DC converter.

(Second Modification)

In the event of a power outage due to a disaster, etc., or outdoors at a camping site, etc., it is desirable if the power system installed in the PHEV or EV can supply power to the outside of the vehicle that is equivalent to power for home use. The second modification is intended to realize this.

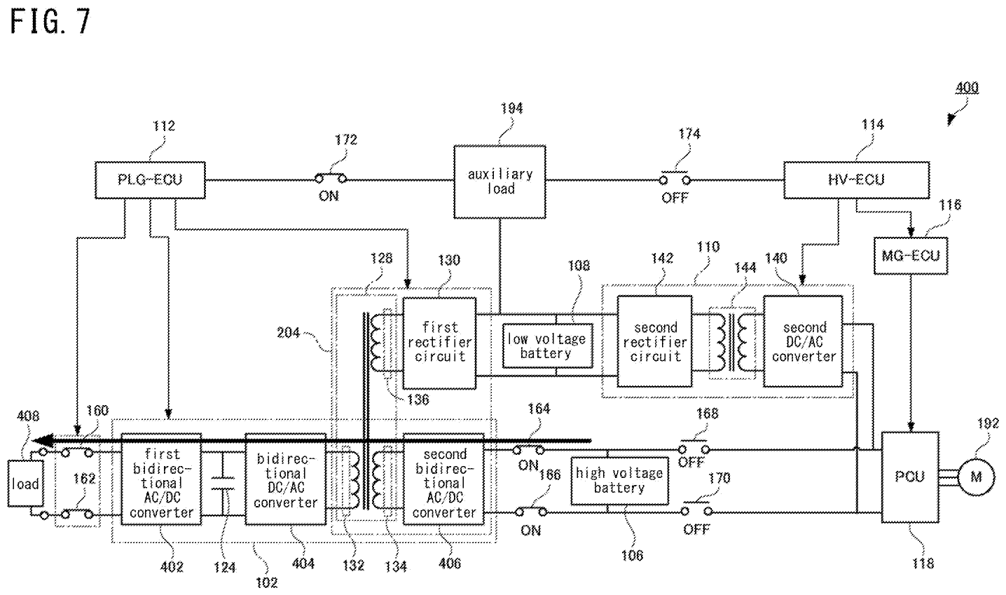

Referring to FIG. 7, a power system 400 according to this modification is configured in the same manner as power system 100 in FIG. 1. Power system 400 is mounted on a PHEV or an EV. Power system 400 differs from power system 100 in the following points. That is, first AC/DC converter 120, first DC/AC converter 122, and second AC/DC converter 126 (see FIG. 1) of power system 100 are replaced by a first bidirectional AC/DC converter 402, a bidirectional DC/AC converter 404, and a second bidirectional AC/DC converter 406, respectively. A dedicated cable or the like having an outlet (not shown) to which a home electric appliance can be connected can be connected to relays 160 and 162.

First bidirectional AC/DC converter 402, bidirectional DC/AC converter 404, and second bidirectional AC/DC converter 406 have a function of bidirectionally converting AC power and DC power. Second bidirectional AC/DC converter 406 functions in the same manner as bidirectional AC/DC converter 202 of the first modification. That is, when the output voltage (AC voltage) from first secondary side end 134 of first transformer 128 is input, second bidirectional AC/DC converter 406 converts the AC voltage into a DC voltage and supplies the DC voltage to high voltage battery 106 (relays 164 and 166 are turned on). When relays 164 and 166 are turned on and a DC voltage is supplied from high voltage battery 106, second bidirectional AC/DC converter 406 converts the DC voltage into an AC voltage and supplies the AC voltage to first secondary side end 134 of the first transformer 128.

Bidirectional DC/AC converter 404, like first DC/AC converter 122, converts the DC voltage supplied from first bidirectional AC/DC converter 402 into an AC voltage and supplies the AC voltage to primary side end 132 of the first transformer 128. In addition, bidirectional DC/AC converter 404 converts an AC voltage supplied from primary side end 132 into a DC voltage and supplies the DC voltage to first bidirectional AC/DC converter 402. As described above, when the DC voltage is supplied from high voltage battery 106 to second bidirectional AC/DC converter 406, the AC voltage is supplied from second bidirectional AC/DC converter 406 to first secondary side end 134 of the first transformer 128. At this time, the coil connected to first secondary side end 134 functions as a primary coil. The coil connected to primary side end 132 functions as a secondary coil. As a result, an AC voltage is generated at primary side end 132. This AC voltage is supplied to bidirectional DC/AC converter 404.

First bidirectional AC/DC converter 402, like first AC/DC converter 120, converts an AC voltage supplied from the outside via relays 160 and 162 into a DC voltage and outputs the DC voltage. In addition, first bidirectional AC/DC converter 402 converts the DC voltage supplied from bidirectional DC/AC converter 404 into an AC voltage and outputs the AC voltage to relays 160 and 162.

Therefore, as described above, by turning on relays 164 and 166 and supplying a DC voltage from high voltage battery 106 to second bidirectional AC/DC converter 406, an AC voltage can be output from relays 160 and 162. When a dedicated cable or the like having an outlet is connected to relays 160 and 162, load 408 (home electric appliance or the like) connected to the outlet can be used. The current direction at this time is shown by a thick arrow in FIG. 7.

The circuit shown in FIG. 6 is also an example of the circuit of first bidirectional AC/DC converter 402, bidirectional DC/AC converter 404, and second bidirectional AC/DC converter 406 shown in FIG. 7. That is, first bidirectional AC/DC converter 402 may be configured in the same circuit as first AC/DC converter 120 in FIG. 6. Bidirectional DC/AC converter 404 and second bidirectional AC/DC converter 406 may be configured in the same circuit as first DC/AC converter 122 and bidirectional AC/DC converter 202 in FIG. 6, respectively.

That is, first bidirectional AC/DC converter 402 may be configured to include inductors 300 and 302 and switch elements 310 to 316 constituting a full bridge circuit. Bidirectional DC/AC converter 404 can be configured to include switch elements 320 to 326 constituting a full bridge circuit and an inductor 328 connected to one of a pair of terminals (a pair of terminals not connected to capacitor 124) of the full bridge circuit. Second bidirectional AC/DC converter 406 may be configured to include switch elements 330 to 336 constituting a full bridge circuit and an inductor 338 connected to one of a pair of terminals (a pair of terminals not connected to terminal 352) of the full bridge circuit.

Accordingly, when a DC voltage is input from terminal 352 (see FIG. 6), second bidirectional AC/DC converter 406 converts the input DC voltage into an AC voltage and outputs the AC voltage. Subsequently, bidirectional DC/AC converter 404 converts the input AC voltage into a DC voltage and outputs the DC voltage. Subsequently, first bidirectional AC/DC converter 402 converts the input DC voltage into an AC voltage and outputs the AC voltage. Thus, AC power equivalent to household power is supplied from terminal 350.

### Second Embodiment

The power system of the first embodiment is mounted on a vehicle (such as a PHEV or an EV) having an external charging function. A power system including a battery does not have an external charging function but is mounted on a hybrid vehicle or the like having an internal charging function. Even for such a vehicle, it is preferable to provide a power system that can be further miniaturized and can reduce a space ratio in the vehicle. This is the purpose of the second embodiment. Hereinafter, the hybrid vehicle is referred to as an HEV (Hybrid Electric Vehicle).

In the HEV, three types of DC power supply voltages (hereinafter referred to as “three power supply systems”) of high voltage, 48V, and 12V are required in order to improve power supply efficiency and ensure redundancy related to automatic operation. When a motor or a generator having the same output is used, the current can be reduced by increasing the drive voltage, and therefore, when 48V power supply is used, the harness can be made smaller and lighter than a 12V power supply. Therefore, the weight of the vehicle is reduced. If the current can be reduced, power consumption can also be reduced. In addition, if multiple power supply lines are provided, power supply can be supplemented by the remaining power supply lines when a failure occurs in some of the power supply lines. This is also the purpose of the second embodiment.

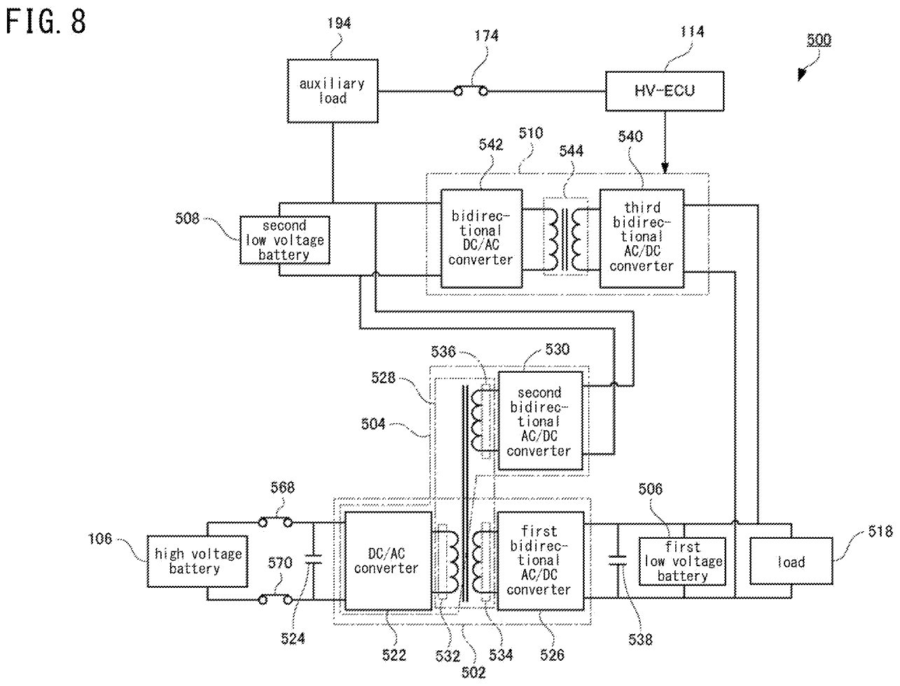

Referring to FIG. 8, a power system 500 according to the second embodiment includes a high voltage battery 106, a first low voltage battery 506, a second low voltage battery 508, a first main DC/DC converter 502, a sub DC/DC converter 504, and a second main DC/DC converter 510. Power system 500 further includes an auxiliary load 194, a load 518, capacitors 524 and 538, and relays 568 and 570. First main DC/DC converter 502, sub DC/DC converter 504, and second main DC/DC converter 510 function as first, second, and third power supply circuits, respectively. High voltage battery 106, first low voltage battery 506, and second low voltage battery 508 function as a first storage battery, a second storage battery, and a third storage battery, respectively. Power for operating elements (for example, semiconductor elements) constituting first main DC/DC converter 502, sub DC/DC converter 504, and second main DC/DC converter 510 is supplied from HV-ECU 114. In FIG. 8, power supply lines to first main DC/DC converter 502 and sub DC/DC converter 504 are not shown for convenience. In FIG. 8, components denoted by the same reference numerals as those in FIG. 1 are the same and have the same functions. Therefore, redundant description thereof will not be repeated.

Power system 500 is mounted on a vehicle having no external charging function such as an HEV. In FIG. 8, a mechanism inside the vehicle for charging high voltage battery 106 is not shown. The HEV is equipped with an engine, a generator and a motor. Various approaches are known as to how the engine, generator and motor are used when the vehicle is running. For example, an engine is mainly used for vehicle running, and when power is required at the time of starting or accelerating the vehicle, a motor is operated by a battery (high voltage battery or the like) to assist vehicle running. High voltage battery 106 is charged by the engine driving the generator or by energy regeneration. Here, energy regeneration refers to causing the motor to function as a generator during vehicle deceleration.

High voltage battery 106 outputs a high voltage (e.g., about 300V) to drive the motor. First low voltage battery 506 is, for example, a storage battery having a charge/discharge voltage of 48V. Second low voltage battery 508 is, for example, a storage battery having a charge/discharge voltage of 12V.

First main DC/DC converter 502 includes a DC/AC converter 522, a first bidirectional AC/DC converter 526, and a first transformer 528. DC/AC converter 522 functions as a power conversion circuit. The input terminal of DC/AC converter 522 is connected to both ends of capacitor 524. First transformer 528 connects an output terminal of DC/AC converter 522 and an input terminal of first bidirectional AC/DC converter 526. Capacitor 524 is connected in parallel high voltage battery 106 via relays 568 and 570. The output terminal of first bidirectional AC/DC converter 526 is connected to first low voltage battery 506 and capacitor 538 which are connected in parallel.

DC/AC converter 522 converts a DC voltage input from high voltage battery 106 through capacitor 524 into an AC voltage and outputs the AC voltage. DC/AC converter 522 functions as an inverter. First bidirectional AC/DC converter 526 converts an input AC voltage into a DC voltage, outputs the DC voltage, and supplies the DC voltage to first low voltage battery 506 and load 518. Load 518 includes auxiliary loads other than auxiliary load 194. The AC voltage input to first bidirectional AC/DC converter 526 is an AC voltage generated at first secondary side end 534 of first transformer 528 when the AC output of DC/AC converter 522 is supplied to primary side end 532 of first transformer 528.

The output voltage of first bidirectional AC/DC converter 526 is preferably a voltage value suitable for charging first low voltage battery 506. In order to generate a voltage (for example, 48V) suitable for charging first low voltage battery 506, first transformer 528 having a transformation ratio (a voltage ratio between a primary side and a secondary side) suitable for the voltage may be used to generate the voltage. That is, by using first transformer 528 having an appropriate voltage ratio between primary side end 532 and first secondary side end 534, a charging voltage suitable for first low voltage battery 506 can be generated.

Sub DC/DC converter 504 includes a DC/AC converter 522, a second bidirectional AC/DC converter 530, and a first transformer 528. First transformer 528 connects an output terminal of DC/AC converter 522 and an input terminal of second bidirectional AC/DC converter 530. Second bidirectional AC/DC converter 530 rectifies and smoothes an input AC voltage and outputs a DC voltage. The AC voltage input to second bidirectional AC/DC converter 530 is an AC voltage generated at second secondary side end 536 of first transformer 528 by supplying the AC output of DC/AC converter 522 to primary side end 532 of first transformer 528. An output terminal of second bidirectional AC/DC converter 530 is connected to second low voltage battery 508 and auxiliary load 194. Thus, DC/AC converter 522 is a component of sub DC/DC converter 504 as well as a component of first main DC/DC converter 502 as described above. That is, DC/AC converter 522 is shared by first main DC/DC converter 502 and sub DC/DC converter 504.

The output voltage of second bidirectional AC/DC converter 530 is preferably a voltage value suitable for charging second low voltage battery 508. In order to generate a voltage (for example, 12V) suitable for charging second low voltage battery 508, first transformer 528 having a transformation ratio (a voltage ratio between a primary side and a secondary side) suitable for the voltage may be used to generate the voltage. That is, by using first transformer 528 having an appropriate voltage ratio between primary side end 532 and second secondary side end 536, a charging voltage suitable for second low voltage battery 508 can be generated.

(Operation During Vehicle Running)

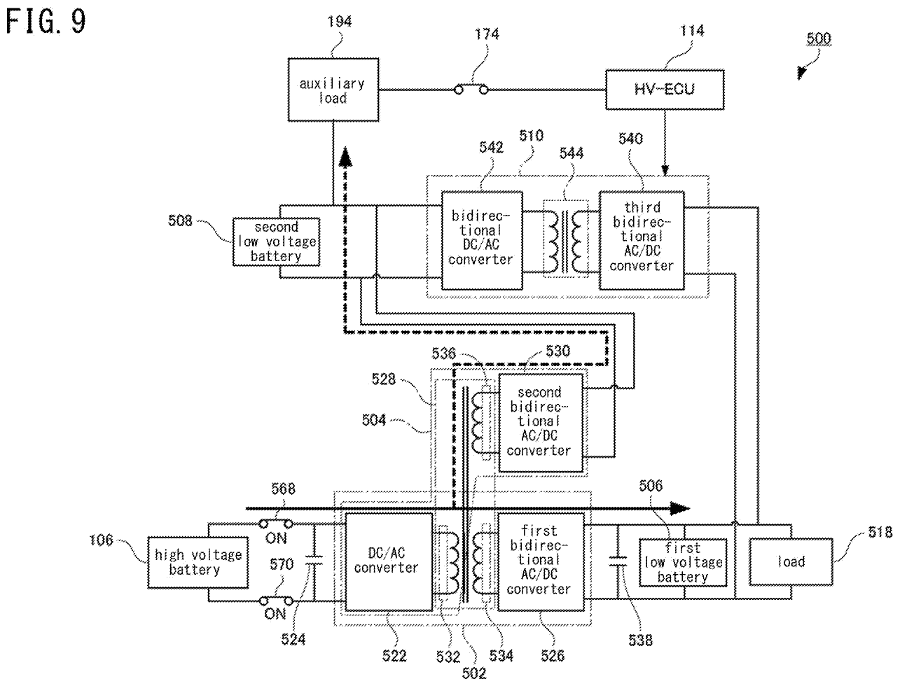

When the vehicle is running, relays 568 and 570 are turned on. This state is shown in FIG. 9. In FIG. 9, the current directions are shown by thick solid arrows and dashed arrows.

When relays 568 and 570 are turned on, the DC voltage from high voltage battery 106 is supplied to DC/AC converter 522. Thus, as described above, the output voltage of first bidirectional AC/DC converter 526 is generated. The output voltage is supplied to first low voltage battery 506 and load 518 (see the thick solid arrow). Thus, first low voltage battery 506 can be charged. Further, by supplying the DC voltage from high voltage battery 106 to DC/AC converter 522, the output voltage of second bidirectional AC/DC converter 530 is generated as described above. The output voltage is supplied to second low voltage battery 508 and auxiliary load 194 (see the dashed arrow). Thus, second low voltage battery 508 can be charged.

DC/AC converter 522 is a common component of first main DC/DC converter 502 and sub DC/DC converter 504. Therefore, power system 500 including the three power supply systems is smaller than a case where the main DC/DC converter and the sub DC/DC converter are separately configured. When power system 500 is mounted on a vehicle, the space ratio of power system 500 in the vehicle can be further reduced. In addition, according to this configuration, it is possible to improve the durability of each component and the power supply efficiency of the entire vehicle while reducing the size of the power system including the three power supply systems.

(Power Supply Between Low Voltage Batteries)

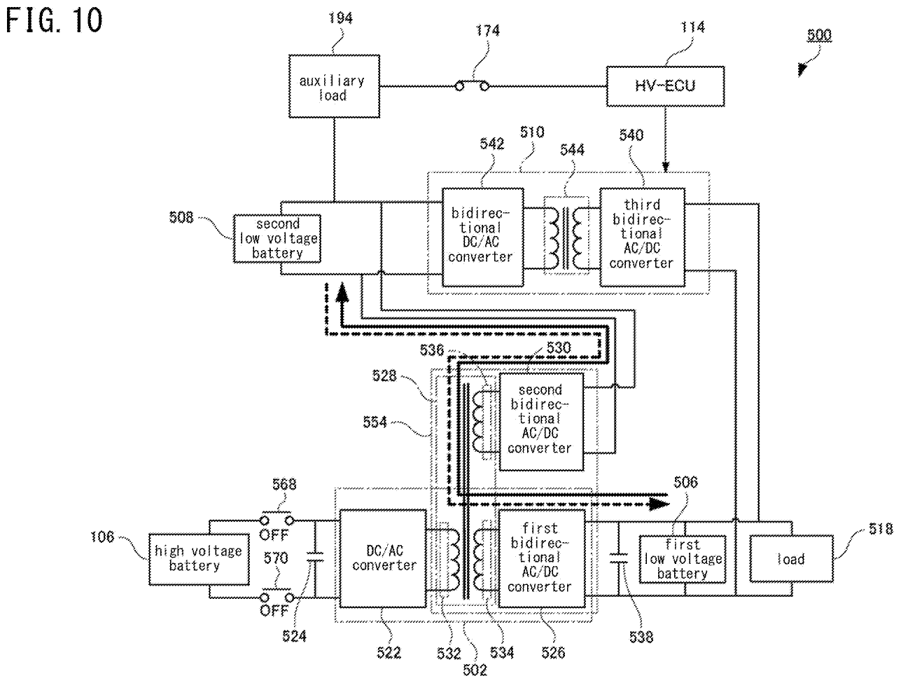

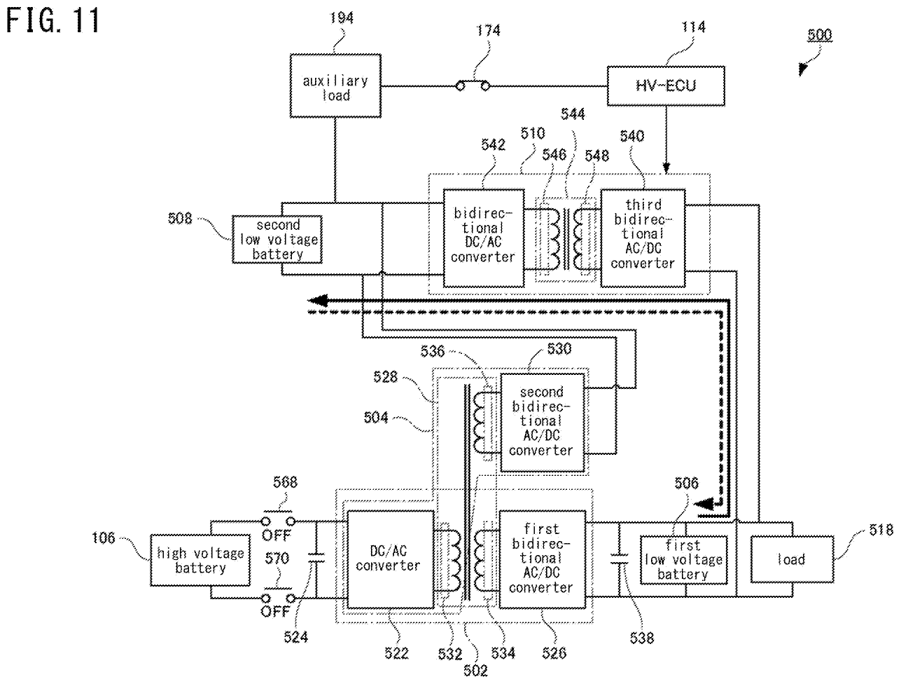

Power system 500 has multiple paths for bidirectionally supplying power between first low voltage battery 506 and second low voltage battery 508. The power supply state between first low voltage battery 506 and second low voltage battery 508 through the first path is shown in FIG. 10. The power supply between first low voltage battery 506 and second low voltage battery 508 through the second path is shown in FIG. 11.

The first path will be described with reference to FIG. 10. First bidirectional AC/DC converter 526 has a function of bidirectionally converting AC power and DC power. Accordingly, power can be bidirectionally supplied between first low voltage battery 506 and second low voltage battery 508 in a state in which relays 568 and 570 are turned off. In FIG. 10, the directions are shown by thick solid arrows and dashed arrows.

That is, first bidirectional AC/DC converter 526 receives an output voltage (AC voltage) from first secondary side end 534 of first transformer 528, converts the AC voltage into a DC voltage, outputs the DC voltage, and supplies the DC voltage to first low voltage battery 506. In addition, when a DC voltage is input from first low voltage battery 506, first bidirectional AC/DC converter 526 converts the DC voltage into an AC voltage, outputs the AC voltage, and supplies the AC voltage to first secondary side end 534 of first transformer 528. Thus, first bidirectional AC/DC converter 526, first transformer 528, and second bidirectional AC/DC converter 530 function as sub DC/DC converter 554. That is, power can be supplied from first low voltage battery 506 to second low voltage battery 508 via sub DC/DC converter 554 (see the thick solid arrow). Therefore, power from first low voltage battery 506 is also supplied to auxiliary load 194. In addition, power can be supplied from second low voltage battery 508 to first low voltage battery 506 via sub DC/DC converter 554 (see a dashed arrow). Power from second low voltage battery 508 is also supplied to load 518.

The second path will be described with reference to FIG. 11. Each of third bidirectional AC/DC converter 540 and bidirectional DC/AC converter 542 has a function of bidirectionally converting DC power and AC power. Accordingly, in a state where relays 568 and 570 are turned off, power can be bidirectionally supplied between first low voltage battery 506 and second low voltage battery 508 via second main DC/DC converter 510. In FIG. 11, the directions are indicated by a thick solid arrow and a dashed arrow.

That is, third bidirectional AC/DC converter 540 converts a DC voltage input from first low voltage battery 506 into an AC voltage and inputs the AC voltage to secondary side end 548 of second transformer 544. As a result, an AC voltage is generated at primary side end 546 of second transformer 544, and the AC voltage is input to bidirectional DC/AC converter 542. Bidirectional DC/AC converter 542 converts an input AC voltage into a DC voltage and supplies the DC voltage to second low voltage battery 508 (refer to a thick solid arrow). Auxiliary load 194 is also supplied with power from first low voltage battery 506. Bidirectional DC/AC converter 542 converts DC power input from second low voltage battery 508 into AC power and inputs the AC power to primary side end 546 of second transformer 544. As a result, an AC voltage is generated at secondary side end 548 of second transformer 544, and the AC voltage is input to third bidirectional AC/DC converter 540. Third bidirectional AC/DC converter 540 converts an input AC voltage into a DC voltage and supplies the DC voltage to first low voltage battery 506 (refer to a dashed arrow). Power from second low voltage battery 508 is also supplied to load 518.

By enabling bidirectional power supply between low voltage batteries, power supply efficiency can be improved. For example, power can be efficiently supplied to each load according to the state of each low voltage battery. Further, by providing multiple bidirectional power supply paths, redundancy of power supply can be realized. Therefore, a more reliable power system can be realized.

The circuit examples of the DC/DC converter 502, sub DC/DC converter 504, and second main DC/DC converter 510 in FIG. 8 will be described with reference to FIG. 6. DC/AC converter 522 and first bidirectional AC/DC converter 526 are configured in the same circuit as first DC/AC converter 122 and bidirectional AC/DC converter 202 in FIG. 6, respectively. That is, first main DC/DC converter 502 constitutes a bidirectional DC/DC converter of the DAB system. Second bidirectional AC/DC converter 530 is configured in a circuit similar to first rectifier circuit 130 in FIG. 6. Bidirectional DC/AC converter 542 and third bidirectional AC/DC converter 540 are configured in the same circuit as first DC/AC converter 122 and bidirectional AC/DC converter 202 in FIG. 6, respectively. That is, second main DC/DC converter 510 constitutes a bidirectional DC/DC converter of the DAB system. Second main DC/DC converter 510 is not limited to the converter of the DAB system. Second main DC/DC converter 510 may be an isolated DC/DC converter using a transformer or a non-isolated DC/DC converter of a chopper system or the like.

(Third Modification)

Also in a vehicle (including a PHEV and an EV) having an external charging function, it is preferable to adopt three power supply systems of high voltage, 48V, and 12V in order to improve power supply efficiency and ensure redundancy related to automatic driving, as in the second embodiment described above. The third variant aims at this.

Referring to FIG. 12, a power system 600 according to this modification is configured by combining power system 100 in FIG. 1 and power system 500 in FIG. 8. A sub system 650 surrounded by a double-dotted line corresponds to power system 100 in FIG. 1. The components other than sub system 650 are the same as the components included in power system 500 in FIG. 8. In FIG. 12, components denoted by the same reference numerals as those in FIGS. 1 and 8 are the same as those in FIGS. 1 and 8, and have the same functions. Therefore, different points will be mainly described, and redundant description will not be repeated.

As shown in FIG. 1, sub system 650 includes relays 168 and 170, a PCU 118 and a drive unit 192 connected to high voltage battery 106 via the relays, and an MG-ECU 116 for controlling PCU 118, which are not shown in FIG. 12 for convenience. For convenience, in FIG. 12, low voltage battery 108 in FIG. 1 is replaced with a second low voltage battery 508.

Sub DC/DC converter 604 corresponds to main DC/DC converter 110 in FIG. 1 and functions as a power supply circuit. Sub DC/DC converter 604 includes a third DC/AC converter 622, a third transformer 628, and a second bidirectional AC/DC converter 530. Third DC/AC converter 622, third transformer 628, and second bidirectional AC/DC converter 530 correspond to second DC/AC converter 140, second transformer 144, and second rectifier circuit 142 in FIG. 1, respectively. In FIG. 12, third DC/AC converter 622 and third transformer 628 replace DC/AC converter 522 and first transformer 528 in FIG. 8 for convenience. That is, sub DC/DC converter 604 corresponds to sub DC/DC converter 504 in FIG. 8. Thus, sub DC/DC converter 604 has the same function as main DC/DC converter 110 shown in FIG. 1. However, second bidirectional AC/DC converter 530 is different from second rectifier circuit 142 in FIG. 1 in that it has a function of converting AC power and DC power bidirectionally.

As described above, for convenience, third DC/AC converter 622 replaces DC/AC converter 522 in FIG. 8, and first main DC/DC converter 602 corresponds to first main DC/DC converter 502 in FIG. 8. That is, first main DC/DC converter 602 has the same function as first main DC/DC converter 502 in FIG. 8.

(Operation During External Charging)

When relays 160 to 166 are turned on during external charging, as in FIG. 3, a DC voltage (output voltage of second AC/DC converter 126) generated from an AC voltage from AC power supply 190 is supplied to high voltage battery 106, and high voltage battery 106 is charged. In addition, a DC voltage (an output voltage of first rectifier circuit 130) generated from an AC voltage supplied from AC power supply 190 is supplied to second low voltage battery 508, and second low voltage battery 508 is charged.

The output voltage (DC voltage) of first rectifier circuit 130 can also be supplied to first low voltage battery 506 via second main DC/DC converter 510 (see FIG. 11). Thus, first low voltage battery 506 is charged while relays 568 and 570 turned off. The output voltage of first rectifier circuit 130 may also be supplied to first low voltage battery 506 via second bidirectional AC/DC converter 530, third transformer 628, and first bidirectional AC/DC converter 526 (see FIG. 10). This also allows first low voltage battery 506 to be charged while relays 568 and 570 off.

(Operation During Vehicle Running)

When the vehicle is running, relays 164 and 166 are turned off, and relays 568 and 570 are turned on. As a result, power (current) is supplied in the same manner as shown in FIG. 9 (see thick solid arrow and dashed arrow). That is, power is supplied from high voltage battery 106 to first low voltage battery 506 and load 518 via first main DC/DC converter 602. Power is supplied from high voltage battery 106 to second low voltage battery 508 and auxiliary load 194 via sub DC/DC converter 604.

In power system 600, first DC/AC converter 122 is a, the first DC/AC converter is a common component to charger 102 and sub DC/DC converter 104. In power system 600, third DC/AC converter 622 is a common component to first main DC/DC converter 602 and sub DC/DC converter 604 as in power system 500 shown in FIG. 8. Therefore, power system 600 including the three power supply systems is smaller than a case where the main DC/DC converter and the sub DC/DC converter are separately configured, and when power system 600 is mounted on a vehicle, a space ratio occupied by power system 600 in the vehicle can be further reduced. In addition, according to this configuration, it is possible to improve the durability of each component and the power supply efficiency of the entire vehicle while reducing the size of the power system including the three power supply systems.

(Power Supply Between Low Voltage Batteries) Power system 600 has multiple paths for bidirectionally supplying power between first low voltage battery 506 and second low voltage battery 508, similarly to power system 500 in FIG. 8. The first path is a path for bidirectionally supplying power between first low voltage battery 506 and second low voltage battery 508 via first bidirectional AC/DC converter 526, third transformer 628, and second bidirectional AC/DC converter 530 (see FIG. 10). The second path is a path for bidirectionally supplying power between first low voltage battery 506 and second low voltage battery 508 via second main DC/DC converter 510 (see FIG. 11).

It is possible to improve power supply efficiency by enabling bidirectional power supply between low voltage batteries. For example, power can be efficiently supplied to each load according to the state of each low voltage battery. Further, by providing multiple bidirectional power supply paths, redundancy of power supply can be realized. Therefore, a more reliable power system can be realized.

In the above description, the case where the power systems 100, 200, 400, 500, and 600 are mounted on a vehicle (PHEV, EV, or HEV) has been described, but the present invention is not limited thereto. The power systems 100, 200, 400, 500, and 600 may be mounted on devices other than vehicles.

Although the present invention has been described with reference to the embodiments, the embodiments are merely examples, and the present invention is not limited only to the embodiments. The scope of the present invention is defined by the appended claims with reference to the detailed description of the invention, and includes all modifications within the meaning and scope equivalent to the wording described therein.

### DESCRIPTION OF REFERENCE

100, 200, 400, 500, 600, 900 power system
102, 902 charger
104, 204, 504, 554, 604, 904 sub DC/DC converter
106, 906 high voltage battery
108, 908 low voltage battery
110, 910 main DC/DC converter
112, 912 PLG-ECU
114, 914 HV-ECU
116, 916 MG-ECU
118, 918 PCU
120 first AC/DC converter
122 first DC/AC converter
124, 346, 524, 538 capacitors
126 second AC/DC converter
128, 528 first transformer
130 first rectifier circuit
132, 532, 546 primary side end
134, 534 first secondary side end
136, 536 second secondary side end
140 second DC/AC converter
142 second rectifier circuit
144, 544 second transformer
160, 162, 164, 166, 168, 170, 172, 174, 568, 570, 960, 962, 964, 966, 968, 970, 972,
974 relay
190, 990 AC power supply
192, 992 drive unit
194, 994 auxiliary load
202 bidirectional AC/DC converter
300, 302, 328, 338, 344 inductor
310, 312, 314, 316, 320, 322, 324, 326, 330, 332, 334, 336, 340, 342 switch element
350, 352, 354 terminal
360 first secondary winding
362 second secondary winding
402, 526 first bidirectional AC/DC converter
404, 542 bidirectional DC/AC converter
406, 530 second bidirectional AC/DC converter
408 load
502, 602 first main DC/DC converter
506 first low voltage battery
508 second low voltage battery
510 second main DC/DC converter
518 load
522 DC/AC converter
540 third bidirectional AC/DC converter
548 secondary side end
622 third DC/AC converter
628 third transformer
650 sub system

1. A power system comprising:
a first power supply circuit that supplies power to a first storage battery; and
a second power supply circuit that is electrically connected to the first power supply circuit and that supplies power to a second storage battery, wherein
the first power supply circuit includes a first power conversion circuit, and
the second power supply circuit uses the first power conversion circuit as a portion of the second power supply circuit and generates power to be supplied to the second storage battery.

2. The power system according to claim 1, wherein the first power conversion circuit includes a power factor improvement circuit, and an inverter circuit connected to the power factor improvement circuit.

3. The power system according to claim 1, wherein
the first power supply circuit further includes:
a transformer having a primary side connected to the first power conversion circuit; and
a converter connected to a first secondary side of the transformer, and
the converter converts power output from the first secondary side of the transformer and supplies the converted power to the first storage battery.

4. The power system according to claim 3, wherein
the second power supply circuit includes a rectifier circuit connected to a second secondary side of the transformer, and
the rectifier circuit rectifies power output from the second secondary side of the transformer and supplies the rectified power to the second storage battery.

5. The power system according to claim 4, wherein
the converter is bidirectional, and
the converter
converts, in response to power being input from the first secondary side of the transformer, the power and outputs the converted power to the first storage battery, and
converts, in response to power being input from the first storage battery, the power and outputs the converted power to the first secondary side of the transformer.

6. The power system according to claim 5, further comprising
a third power supply circuit that converts power from the first storage battery, wherein
in response to the converter outputting power to the first secondary side of the transformer, the second power supply circuit and the third power supply circuit supply power to the second storage battery.

7. The power system according to claim 1, further comprising:
a third storage battery;
a fourth power supply circuit that supplies output power of the first storage battery to the third storage battery; and
a fifth power supply circuit that supplies output power of the first storage battery to the second storage battery, wherein
the fourth power supply circuit includes a second power conversion circuit, and
the fifth power supply circuit uses the second power conversion circuit as a portion of the fifth power supply circuit and generates power to be supplied to the second storage battery.

8. The power system according to claim 7, wherein
the fourth power supply circuit and the fifth power supply circuit
convert, in response to power being input to the fifth power supply circuit from the second storage battery, the power and supply the converted power from the fourth power supply circuit to the third storage battery, and
convert, in response to power being input to the fourth power supply circuit from the third storage battery, the power and supply the converted power from the fifth power supply circuit to the second storage battery.

9. The power system according to claim 7, further comprising
a sixth power supply circuit, wherein
the sixth power supply circuit
converts, in response to power being input from the second storage battery, the power and supplies the converted power to the third storage battery, and
converts, in response to power being input from the third storage battery, the power and supplies the converted power to the second storage battery.

10. A power system comprising:
a first storage battery;
a second storage battery;
a third storage battery;
a first power supply circuit that supplies output power of the first storage battery to the second storage battery; and
a second power supply circuit that supplies output power of the first storage battery to the third storage battery, wherein
the first power supply circuit includes a power conversion circuit, and
the second power supply circuit uses the power conversion circuit as a portion of the second power supply circuit and generates power to be supplied to the third storage battery.

11. The power system according to claim 10, wherein
the first power supply circuit and the second power supply circuit
convert, in response to power being input to the first power supply circuit from the second storage battery, the power and supply the converted power from the second power supply circuit to the third storage battery, and
convert, in response to power being input to the second power supply circuit from the third storage battery, the power and supply the converted power from the first power supply circuit to the second storage battery.

12. The power system according to claim 10, further comprising
a third power supply circuit, wherein
the third power supply circuit
converts, in response to power being input from the second storage battery, the power and supplies the converted power to the third storage battery, and
converts, in response to power being input from the third storage battery, the power and supplies the converted power to the second storage battery.

13. (canceled)
